(19) United States
(12) Patent Application Publication
(10) Pub. No.: US 2015/0200502 A1
(43) Pub. Date: Jul. 16, 2015

(54) CABLE WITH CONNECTOR

(71) Applicant: Hitachi Metals, Ltd., Tokyo (JP)

(72) Inventors: Kei NISHIMURA, Hitachi (JP); Izumi FUKASAKU, Hitachi (JP); Takahiro SUGIYAMA, Hitachi (JP)

(21) Appl. No.: 14/549,419

(22) Filed: Nov. 20, 2014

(30) Foreign Application Priority Data
Jan. 15, 2014 (JP) 2014-005013

(51) Int. Cl. H01R 24/60; H01R 13/6586; H01R 13/6473

(52) U.S. Cl. CPC H01R 24/60; H01R 13/6473; H01R 13/6586

(57) ABSTRACT

A cable with connector includes differential signal transmission cables, a connector at both ends of the cables, a paddle card to electrically connect the differential signal transmission cables to a connected device, sending-side electrodes and receiving-side electrodes that are formed on each of front and rear surfaces of the paddle card at one end portion thereof and are electrically connected to the device, sending-side cable connection electrodes, and receiving-side cable connection electrodes. The sending-side cable connection electrodes are formed on the front surface of the paddle card and the receiving-side cable connection electrodes are formed on the rear surface of the paddle card. The paddle card includes a via to electrically connect the sending-side electrodes formed on the rear surface and the corresponding sending-side cable connection electrodes and a via to electrically connect the receiving-side electrodes formed on the front surface and the corresponding receiving-side cable connection electrodes.

The present application is based on Japanese patent application No.2014-005013 filed on Jan. 15, 2014, the entire contents of which are incorporated herein by reference.

### BACKGROUND OF THE INVENTION

1. Field of the Invention

The invention relates to a cable with connector.

2. Description of the Related Art

A cable with connector is known which is provided with a cable including plural differential signal transmission cables and connectors provided at both ends of the cable.

The connector has a built-in paddle card for electrically connecting the differential signal transmission cables to a connection destination device. There is a product called an active cable module (also called an active direct attach cable, an active DAC or an active copper cable (ACC)) which is provided with a compensation circuit for actively compensating electrical signals according to loss characteristics of the differential signal transmission cables and then outputting the compensated signals on a receiving-side transmission path in the paddle card, i.e., on a transmission path for transmitting electrical signals input from the differential signal transmission cables to the device.

As shown in FIGS. 4A to 4C, a cable with connector 41 is provided with a cable 43 including plural differential signal transmission cable 42, connectors 44 provided at both ends of the cable 43, and each paddle card 45 included in the connector 44 and electrically connecting the differential signal transmission cables 42 to a connection destination device (not shown). The cable with connector 41 is configured to allow for four-channel transmission and reception and is provided with eight differential signal transmission cables 42 in total, four for transmission purpose and four for reception purpose. In the drawings, TX represents transmission, RX represents reception and the number after TX or RX is a channel number.

Plural sending-side electrodes 46 and plural receiving-side electrodes 47, which are to be connected to a device, are formed on one end portion of the paddle cards 45. In addition, plural sending-side cable connection electrodes 48 to be electrically connected to the differential signal transmission cables 42 for transmit and plural receiving-side cable connection electrodes 49 to be electrically connected to the differential signal transmission cables 42 for receive are formed on another end portion of the paddle cards 45.

The sending-side electrodes 46 and the corresponding sending-side cable connection electrodes 48 are electrically connected by sending-side transmission paths 50. Meanwhile, the receiving-side electrodes 47 and the corresponding receiving-side cable connection electrodes 49 are electrically connected by receiving-side transmission paths 51. Compensation circuits 52 actively compensating electrical signals according to loss characteristics of the differential signal transmission cables 42 and then outputting the compensated signals are provided on the receiving-side transmission paths 51.

In the cable with connector 41, the sending-side transmission paths 50 are gathered on the left side in FIG. 4C and the receiving-side transmission paths 51 are gathered on the right side. Thus, grounding layers 53 as inner layers of the paddle card 45 are formed left and right so as to be divided on the sending side and on the receiving side, thereby reducing crosstalk between transmission and reception.

In the meantime, for the cable with connector 41, a position to form the sending-side electrodes 46 and the receiving-side electrodes 47, i.e., an electrode layout at a portion to be connected to a device, is specified by SFF-8436 (SFF-8436 Specification for QSFP+ 10 Gbs 4X PLUGGABLE TRANSCEIVER Rev 4.4). Thus, both the sending-side electrodes 46 and the receiving-side electrodes 47 are formed on each of the front and rear surfaces of the paddle card 45.

Therefore, the conventional cable with connector 41 has a structure in which the differential signal transmission cables 42 for transmit and the differential signal transmission cables 42 for receive are connected to the same layer (i.e., a structure in which the differential signal transmission cables 42 both for transmit and receive are connected to each of the front and rear surfaces of the paddle card 45) and both the sending-side transmission paths 50 and the receiving-side transmission paths 51 are thus formed on the same layer.

JP-A-2011-90959 and JP-A-2013-122825 may be prior art documents related to the present invention.

### SUMMARY OF THE INVENTION

In the cable with connector such as active cable module, the signal level difference between the sending side and the receiving side is generally large especially in long-distance transmission using a long cable and it is more susceptible to near-end crosstalk due to common mode.

The cable with connector 41 may have the problem that particularly near-end crosstalk is likely to be increased since the sending-side transmission paths 50 and the receiving-side transmission paths 51 are formed on the same layer.

Also, the cable with connector 41 may have the problem that one compensation circuit 52 cannot be shared since the receiving-side transmission paths 51 are formed on both the front and rear surfaces of the paddle card 45, resulting in an increase in the number of components.

It is an object of the invention to provide a cable with connector that reduces the near-end crosstalk and the number of components.
(1) According to one embodiment of the invention, a cable with connector comprises:
   a cable comprising a plurality of differential signal transmission cables; a connector at both ends of the cable;
   a paddle card comprising a multi-layer board and provided inside the connector to electrically connect the differential signal transmission cables to a connected device;
   a plurality of sending-side electrodes and a plurality of receiving-side electrodes that are formed on each of front and rear surfaces of the paddle card at one end portion thereof and are electrically connected to the device;
   a plurality of sending-side cable connection electrodes formed on an other end portion of the paddle card and electrically connected to the differential signal transmission cables for transmission; and
   a plurality of receiving-side cable connection electrodes formed on the other end portion of the paddle card and electrically connected to the differential signal transmission cables for reception,
   wherein the plurality of sending-side cable connection electrodes are formed on the front surface of the paddle card and the plurality of receiving-side cable connection electrodes are formed on the rear surface of the paddle card, and
   wherein the paddle card further comprises a via to electrically connect the sending-side electrodes formed on the rear surface of the paddle card and the corresponding sending-side cable connection electrodes and a via to electrically connect the receiving-side electrodes formed on the front surface of the paddle card and the corresponding receiving-side cable connection electrodes.

In the above embodiment (1) of the invention, the following modifications and changes can be made.
(i) The paddle card further comprises a compensation circuit on the rear surface thereof so as to compensate and output electrical signals input from the differential signal transmission cables according to loss characteristics of the differential signal transmission cables.
(ii) The compensation circuit comprises one applicable to multiple channels.
(iii) The paddle card comprises two grounding layers between the front and rear surfaces thereof.
(iv) The differential signal transmission cables are arranged such that a conductor-exposed portion exposed at an end portion thereof overlaps with the grounding layers in a plan view.
(v) The differential signal transmission cables are arranged such that a conductor-exposed portion exposed at an end portion thereof protrudes out of the grounding layers in a plan view, and wherein a shielding metal plate is provided between the conductor-exposed portions of the differential signal transmission cables that are arranged sandwiching the paddle card, the conductor-exposed portions protruding out of the grounding layers.

### Advantageous Effects of the Invention

According to one embodiment of the invention, a cable with connector can be provided that reduces the near-end crosstalk and the number of components.

### BRIEF DESCRIPTION OF THE DRAWINGS

Next, the present invention will be explained in more detail in conjunction with appended drawings, wherein:

FIGS. 1A to 1C are diagrams illustrating a cable with connector in an embodiment of the present invention, wherein FIG. 1A is a plan view as viewed from the front side,

FIG. 1B is a plan view as viewed from the back side and FIG. 1C is a cross sectional view taking on line 1C-1C in FIG. 1A;

FIG. 2 is a plan view showing a modification of the cable with connector of FIGS. 1A to 1C as viewed from the back side;

FIG. 3A is a cross sectional view showing a cable connection portion in the cable with connector of FIGS. 1A to 1C;

FIG. 3B is a cross sectional view showing a modification thereof; and

FIGS. 4A to 4C are diagrams illustrating a conventional cable with connector, wherein FIG. 4A is a plan view as viewed from the front side, FIG. 4B is a plan view as viewed from the back side and FIG. 4C is a cross sectional view taking on line 4C-4C in FIG. 4A.

### DETAILED DESCRIPTION OF THE PREFERRED EMBODIMENT

An embodiment of the invention will be described below in conjunction with the appended drawings.

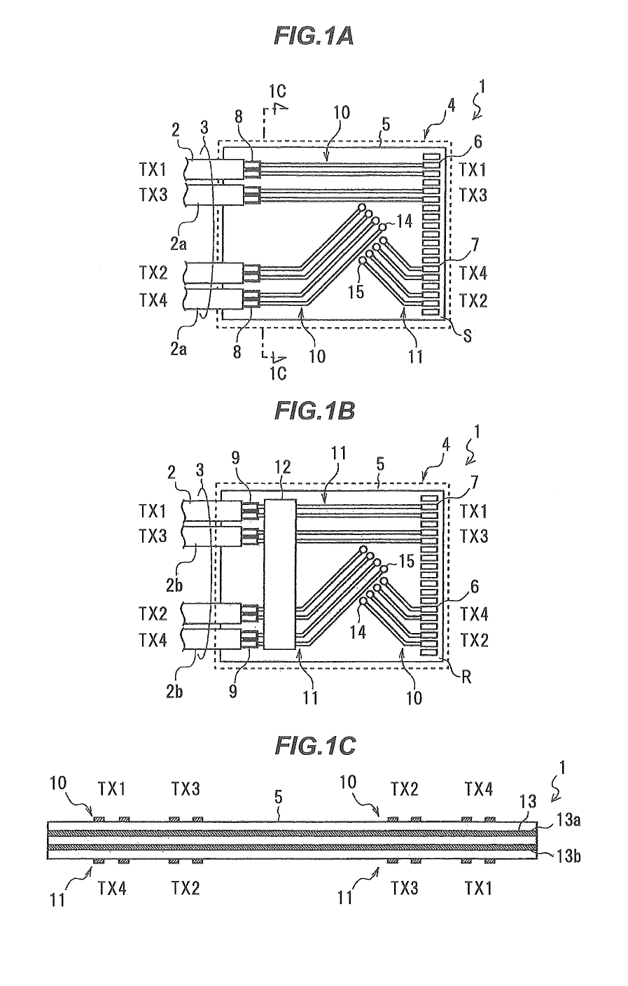

FIGS. 1A to 1C are diagrams illustrating a cable with connector in the present embodiment, wherein FIG. 1A is a plan view as viewed from the front side, FIG. 1B is a plan view as viewed from the back side and FIG. 1C is a cross sectional view taking on line 1C-1C in FIG. 1A. FIG. 1B is a plan view when turning FIG. 1A over to be upside down.

As shown in FIG. 1A to 1C, a cable with connector 1 is provided with a cable 3 including plural differential signal transmission cables 2, connectors 4 provided at both ends of the cable 3, and a paddle card 5 which is formed of a multi-layer board and is provided inside each connector 4 to electrically connect the differential signal transmission cables 2 to a connection destination device (not shown).

The cable with connector 1 configured to allow for four-channel transmission and reception will be described in the present embodiment. In this case, eight differential signal transmission cables 2 in total, for transmission purpose and four for reception purpose, are provided. In the drawings, TX represents transmission, RX represents reception and the number after TX or RX is a channel number.

Plural sending-side electrodes 6 and plural receiving-side electrodes 7, which are to be electrically connected to a device, are formed on a front surface S as well as a rear surface R of the paddle card 5 at one end portion thereof (an end portion opposite to the side connected to the cable 3). On the front and rear surfaces S and Rat the one end portion of the paddle card 5, ground electrodes, power electrodes and control signal electrodes, etc., are formed in a line in addition to the sending-side electrodes 6 and the receiving-side electrodes 7, thereby forming a card-edge connector. Each electrode constituting the card-edge connector is arranged so as to meet SFF-8436.

Plural sending-side cable connection electrodes 8 electrically connected to the differential signal transmission cables 2a for transmit and plural receiving-side cable connection electrodes 9 electrically connected to the differential signal transmission cables 2b for receive are formed on another end portion of the paddle card 5 (an end portion on the side connected to the cable 3). In the present specification, output of electrical signal form the paddle card 5 to the differential signal transmission cable 2 is defined as send, and input of electrical signal form the differential signal transmission cable 2 to the paddle card 5 is defined as receive.

The sending-side electrodes 6 are electrically connected to the corresponding sending-side cable connection electrodes 8 via sending-side transmission paths 10. Through the sending-side transmission paths 10, electrical signals input from the device via the sending-side electrodes 6 are transmitted to the sending-side cable connection electrodes 8 and then to the differential signal transmission cables 2a. The sending-side transmission path 10 consists mainly of a wiring pattern formed on the paddle card 5.

The receiving-side electrodes 7 are electrically connected to the corresponding receiving-side cable connection electrodes 9 via receiving-side transmission paths 11. Through the receiving-side transmission paths 11, electrical signals input from the differential signal transmission cables 2b via the receiving-side cable connection electrodes 9 are transmitted to the receiving-side electrodes 7 and then to a device. The receiving-side transmission path 11 consists mainly of a wiring pattern formed on the paddle card 5.

The cable with connector 1 of the present embodiment is configured that the plural sending-side cable connection electrodes 8 are formed on the front surface S and the plural receiving-side cable connection electrodes 9 on the rear surface R of the paddle card 5 so that all of the differential signal transmission cables 2a for transmit are connected to the paddle card 5 on the front surface S side and all of the differential signal transmission cables 2b for receive are connected to the paddle card 5 on the rear surface R side.

In the cable with connector 1, since all of the sending-side cable connection electrodes 8 are formed on the front surface S of the paddle card 5, the sending-side electrodes 6 formed on the rear surface R of the paddle card 5 are electrically connected to the corresponding sending-side cable connection electrodes 8 through vias 14 formed on the paddle card 5.

Likewise, in the cable with connector 1, since all of the receiving-side cable connection electrodes 9 are formed on the rear surface R of the paddle card 5, the receiving-side electrodes 7 formed on the front surface S of the paddle card 5 are electrically connected to the corresponding receiving-side cable connection electrodes 9 through vias 15 formed on the paddle card 5. The vias 14 and 15 are through-holes exclusively for an electrical connection between layers and are also called a via hole. The through-type vias 14 and 15 are used here to connect between the front and rear surfaces S and R of the paddle card 5.

An inner layer between the front surface S and the rear surface R of the paddle card 5 is provided with a grounding layer 13 composed of two layers. Each of the two layers of the grounding layer 13 is formed to spread the entire paddle card 5. Here, a grounding layer 13a on the front surface S side of the paddle card 5 is associated with the sending-side transmission paths 10 and a grounding layer 13b on the rear surface R side is associated with the receiving-side transmission paths 11. This allows the grounding layer 13 with a large area to be provided while suppressing crosstalk by dividing the grounding layer 13 into the sending-side layer and the receiving-side layer.

The grounding layer 13 serves as a shielding between the sending-side transmission paths 10 formed on the front surface S of the paddle card 5 and the receiving-side transmission paths 11 formed on the rear surface R to reduce the near-end crosstalk.

In the present embodiment, a portion of some sending-side transmission paths 10 (a portion on the sending-side electrode 6 side of the via 14) is formed on the rear surface R of the paddle card 5 and a portion of some receiving-side transmission paths 11 (a portion on the receiving-side electrode 7 side of the via 15) is formed on the front surface S of the paddle card 5. A path length of the sending-side transmission path 10 formed on the rear surface R of the paddle card 5 and a path length of the receiving-side transmission path 11 formed on the front surface S of the paddle card 5 are desirably as short as possible. Thus, it is desirable that the vias 14 and 15 be formed at an edge of the paddle card 5 (opposite to the side connected to the cable 3), if possible. The positions of the vias 14 and 15 and the layout of the wiring pattern in FIGS. 1A to 1C are only an example and various changes can be made.

The receiving-side transmission paths 11 on the rear surface R of the paddle card 5 are provided with a compensation circuit 12 by which electrical signals input from the differential signal transmission cables 2b are actively compensated according to loss characteristics of the differential signal transmission cables 2b and are then output. That is, the cable with connector 1 is an active cable module in which each connector 4 is provided with the compensation circuit 12.

It is desirable to use the compensation circuit 12 applicable to multichannel transmission. In the present embodiment, since the receiving-side transmission paths 11 are all formed on the rear surface R of the paddle card 5, the compensation circuit 12 can be shared by all channels. Use of the compensation circuit 12 to be shared by all channels allows the number of components and the cost to be reduced. In addition, it is possible to reduce crosstalk between channels by using the multichannel compensation circuit 12.

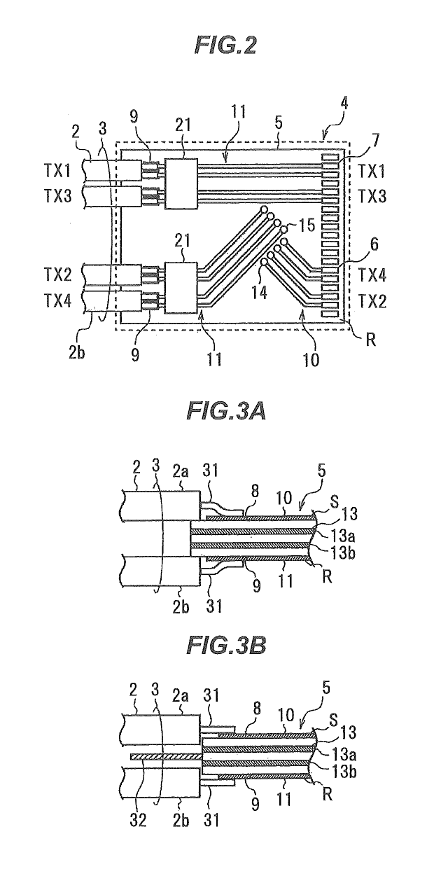

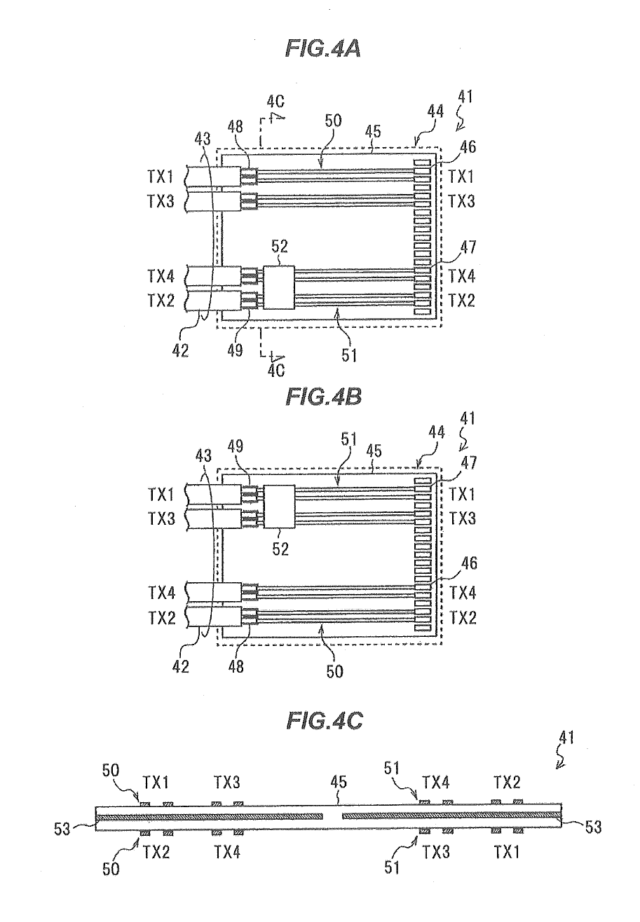

The case of providing the compensation circuit 12 shared by four channels is shown as an example in FIGS. 1A to 1C, it is not limited thereto. Two dual-channel compensation circuits 21 may be used, as shown in FIG. 2.

Meanwhile, as shown FIG. 3A, the differential signal transmission cable 2 is desirably arranged so that a conductor (an inner conductor 31 and a non-illustrated outer conductor) exposed at an end portion thereof overlaps with the grounding layer 13 in a plan view. The reason is as follows. In the cable with connector 1, the differential signal transmission cables 2a for transmit and the differential signal transmission cables 2b for receive are arranged so that the paddle card 5 is sandwiched therebetween. Therefore, if the exposed portion of the inner conductor 31 or the outer conductor protrudes out of the grounding layer 13, a shielding effect of the grounding layer 13 is not obtained at such a portion and near-end crosstalk is increased.

When the extended inner conductor 31 is not bent and connected to the electrodes 8 or 9 so that an end face of the differential signal transmission cables 2 butts against an end face of the paddle card 5 as shown in FIG. 3B, the exposed portion of the inner conductor 31 or the outer conductor partially protrudes out of the grounding layer 13 in a plan view. In such a case, a shielding metal plate 32 is provided between the differential signal transmission cables 2a and 2b which are arranged sandwiching the paddle card 5, i.e., between the conductor-exposed portions protruding out of the grounding layer 13, to reduce near-end crosstalk.

As described above, the cable with connector 1 of the present embodiment is configured that the plural sending-side cable connection electrodes 8 are formed on the front surface S of the paddle card 5 and the plural receiving-side cable connection electrodes 9 on the rear surface R, and the vias 14 and 15 formed on the paddle card 5 are used for electrical connection between the sending-side electrodes 6 formed on the rear surface R of the paddle card 5 and the corresponding sending-side cable connection electrodes 8 and between the receiving-side electrodes 7 formed on the front surface S of the paddle card 5 and the corresponding receiving-side cable connection electrodes 9.

Such a configuration allows the sending-side transmission paths 10 and the receiving-side transmission paths 11 to be formed on different layers and it is thus possible to reduce near-end crosstalk more than the conventional cable with connector in which the sending-side transmission paths 10 and the receiving-side transmission paths 11 are formed on the same layer.

In addition, in the cable with connector 1, since all of the receiving-side transmission paths 11 are formed on the rear surface R of the paddle card 5, it is possible to mount the compensation circuit 12 to be shared and thus possible to reduce the number of components and the cost.

The present invention is not intended to be limited to the embodiment, and it is obvious that the various kinds of changes can be made without departing from the gist of the invention.

For example, although connection between the sending-side electrodes 6 formed on the rear surface R of the paddle card 5 and the corresponding sending-side cable connection electrodes 8 using the vias 14 and between the receiving-side electrodes 7 formed on the front surface S of the paddle card 5 and the corresponding receiving-side cable connection electrodes 9 using the vias 15 has been described in the embodiment, it is possible to configure to connect using the vias 14 and 15 as well as an inner layer wiring of the paddle card 5.

In addition, although the case of providing the compensation circuit 12 on the receiving-side transmission paths 11 has been described in the embodiment, the compensation circuit 12 is not essential and can be omitted.

What is claimed is:

1. A cable with connector, comprising:
a cable comprising a plurality of differential signal transmission cables;
a connector at both ends of the cable;
a paddle card comprising a multi-layer board and provided inside the connector to electrically connect the differential signal transmission cables to a connected device;
a plurality of sending-side electrodes and a plurality of receiving-side electrodes that are formed on each of front and rear surfaces of the paddle card at one end portion thereof and are electrically connected to the device;
a plurality of sending-side cable connection electrodes formed on an other end portion of the paddle card and electrically connected to the differential signal transmission cables for transmission; and
a plurality of receiving-side cable connection electrodes formed on the other end portion of the paddle card and electrically connected to the differential signal transmission cables for reception,
wherein the plurality of sending-side cable connection electrodes are formed on the front surface of the paddle card and the plurality of receiving-side cable connection electrodes are formed on the rear surface of the paddle card, and wherein the paddle card further comprises a via to electrically connect the sending-side electrodes formed on the rear surface of the paddle card and the corresponding sending-side cable connection electrodes and a via to electrically connect the receiving-side electrodes formed on the front surface of the paddle card and the corresponding receiving-side cable connection electrodes.

2. The cable with connector according to claim 1, wherein the paddle card further comprises a compensation circuit on the rear surface thereof so as to compensate and output electrical signals input from the differential signal transmission cables according to loss characteristics of the differential signal transmission cables.

3. The cable with connector according to claim 2, wherein the compensation circuit comprises one applicable to multiple channels.

4. The cable with connector according to claim 1, wherein the paddle card comprises two grounding layers between the front and rear surfaces thereof.

5. The cable with connector according to claim 2, wherein the paddle card comprises two grounding layers between the front and rear surfaces thereof.

6. The cable with connector according to claim 3, wherein the paddle card comprises two grounding layers between the front and rear surfaces thereof.

7. The cable with connector according to claim 4, wherein the differential signal transmission cables are arranged such that a conductor-exposed portion exposed at an end portion thereof overlaps with the grounding layers in a plan view.

8. The cable with connector according to claim 5, wherein the differential signal transmission cables are arranged such that a conductor-exposed portion exposed at an end portion thereof overlaps with the grounding layers in a plan view.

9. The cable with connector according to claim 6, wherein the differential signal transmission cables are arranged such that a conductor-exposed portion exposed at an end portion thereof overlaps with the grounding layers in a plan view.

10. The cable with connector according to claim 4, wherein the differential signal transmission cables are arranged such that a conductor-exposed portion exposed at an end portion thereof protrudes out of the grounding layers in a plan view, and wherein a shielding metal plate is provided between the conductor-exposed portions of the differential signal transmission cables that are arranged sandwiching the paddle card, the conductor-exposed portions protruding out of the grounding layers.

11. The cable with connector according to claim 5, wherein the differential signal transmission cables are arranged such that a conductor-exposed portion exposed at an end portion thereof protrudes out of the grounding layers in a plan view, and wherein a shielding metal plate is provided between the conductor-exposed portions of the differential signal transmission cables that are arranged sandwiching the paddle card, the conductor-exposed portions protruding out of the grounding layers.

12. The cable with connector according to claim 6, wherein the differential signal transmission cables are arranged such that a conductor-exposed portion exposed at an end portion thereof protrudes out of the grounding layers in a plan view, and wherein a shielding metal plate is provided between the conductor-exposed portions of the differential signal transmission cables that are arranged sandwiching the paddle card, the conductor-exposed portions protruding out of the grounding layers.
